(19) United States
(12) Patent Application Publication
(10) Pub. No.: US 2002/0016750 A1
(43) Pub. Date: Feb. 7, 2002

(54) System and method for scan-based input, storage and retrieval of information over an interactive communication network

(76) Inventor: Olivier Attia, New York, NY (US)

Correspondence Address: Scanbuy, Inc., 9th Floor, 15 West 39th Street, New York, NY, 10018, US

(21) Appl. No.: 09/883,933

(22) Filed: Jun. 20, 2001

Related U.S. Application Data
(60) Provisional application No. 60/212,575, filed on Jun. 20, 2000.

(51) Int. Cl. G06F 17/60

(52) U.S. Cl. 705/26

(57) ABSTRACT

The invention comprises the system and methods for Shoppers to facilitate their Shopping experience by creating and managing Accounts (to store their Billing, Shipping, Credit Card information and Shopping Lists or Folders) through an interactive Communication Network, such as the Internet, using Barcodes Scanners and other computing or communication appliances. Customers or shoppers upload barcodes using a personal scanner to the centralized data repository which stores this information in the User's folders, view product information in the Products Database on these appliances; organize their Shopping Lists (or Folders) by dragging and dropping products from one Folder to another; and use folders to directly check out and place Orders without having to re-enter their billing, shipping, and credit card information—thus accomplishing purchases with the minimum data entry or actions. There is also a component that detects and recommends a Substitute when a product, which the customer wishes to buy, is not available in the store that implements the present system.

### FIELD OF THE INVENTION

This invention relates to methods and apparatus for creating, storing, managing and using customized Shopping Folders or Shopping Lists through an interactive Communication Network, such the Internet; and using these Folders to conduct online shopping utilizing methods that minimize customer actions.

### BACKGROUND OF THE INVENTION

In a typical Shopping scenario, a Customer initiates the Shopping Process by preparing a Shopping List that comprises the Name or Description and Quantity of the products that s/he wishes to buy. The shopping experience is greatly simplified and expedited if the Customer could save the Shopping List, and re-use the entire list, or parts of it, in different shopping scenarios.

Let us first consider an Internet shopping scenario. Typically, a Customer goes to a website offering Internet Shopping services; searches for the products s/he wishes to buy; adds them to the Shopping Cart; checks out; fills up Order information such as Name, Billing & Shipping Addresses and Credit Card information; and then submits the Order. Usually, the Customer comes back to the same website and goes through the entire cycle again in a subsequent shopping session.

In order that Customers do not have to repeatedly provide information or undergo the complete cycle every time they shop, a large number of websites these days allows Customers to create Accounts to save Billing, Shipping and Credit Card information. Some websites go a little further to allow Customers to create, save, and reuse Shopping Lists. Nonetheless, no website or web solution other than the ‘My Shopping Folders’ component of the ScanCommerce System provides a very flexible, user-friendly, simple and complete means of managing Shopping Lists on a Website.

The ScanCommerce System is a Web-based product that can be implemented, in its entirety or in part, as a website or web application. Hereafter, the term “Aggregator Website” is used to refer to a website utilizing one or more components of the ScanCommerce solution, to provide a range of eCommerce services.

ScanShopping services are available on Aggregator Websites using the ScanBuyer Subsystem—one of the several components of the ScanCommerce solution. ScanShopping services, as the name implies, allows customers to shop for products using personal barcode scanners. A customer, who has already registered at the Aggregator Website, scans the barcode of the desired product from a catalog, magazine, or product packaging using a handheld scanner. These barcodes first get stored in the scanner memory. After logging into his/her Account on the Aggregator Website, the User uploads the entire list (of barcodes scanned) to this website through a Personal Computer, by either attaching the Scanner or syncing it with a bandheld device (such as Personal Digital Assistants, Mobile Phones, etc.) to which the scanner is attached. A list of the scanned barcodes is uploaded to the website in the form of a text file, which is parsed by a ScanCommerce application component on the Web Server. Each of these scanned barcodes then gets stored in the Shopping Cart folder of this said User.

The Shopping Cart folder is one of the several customized folders (generally referred to as “My Shopping Folders”) available to the User through his/her Account in the Aggregator site. These folders are created, stored, managed and used through the Folder Management Module of the ScanBuyer Subsystem. “My Shopping Folders” are classified into two categories: Standard Folders that are automatically created by the ScanCommerce System after the successful creation of a User Account; and User-Created Folders that are created by the User himself or herself.

Complete details of the present invention—“My Shopping Folders”—such as descriptions, features, processes, and advantages are given under “Detailed Description”. In the course of this description, frequent reference will be made to the attached drawings.

### BRIEF DESCRIPTION OF THE DRAWINGS

FIG. 1 is a schematic block diagram illustrating various instrumentalities and entities, interconnected via the Internet, which make use of the invention

FIG. 2 is a is a schematic block diagram illustrating various kinds of My Shopping Folders, for various kinds of Users (Customers).

FIGS. 3, 4 and 5 are diagrams showing the principal data structures of the various folders & Users, and their interrelationships.

### DETAILED DESCRIPTION

The present invention aims to simplify and minimize Customer actions and processes involved in shopping—particularly for those customers who shop for almost a fixed set of items or products on almost a regular basis—by allowing the creation, storage and management of Shopping Lists (“My Shopping Folders”) on the Aggregator Website. The invention permits Customers to maintain and manage these lists from any location in the world through the Internet. The System will also permit the Users (Customers) to access their Folders or Shopping Lists not only though PC-based Web Browsers, such as the Internet Explorer or Netscape navigator, from home or Office, but also through POS Terminals or special appliances installed at various retail stores that participate in the Aggregator website.

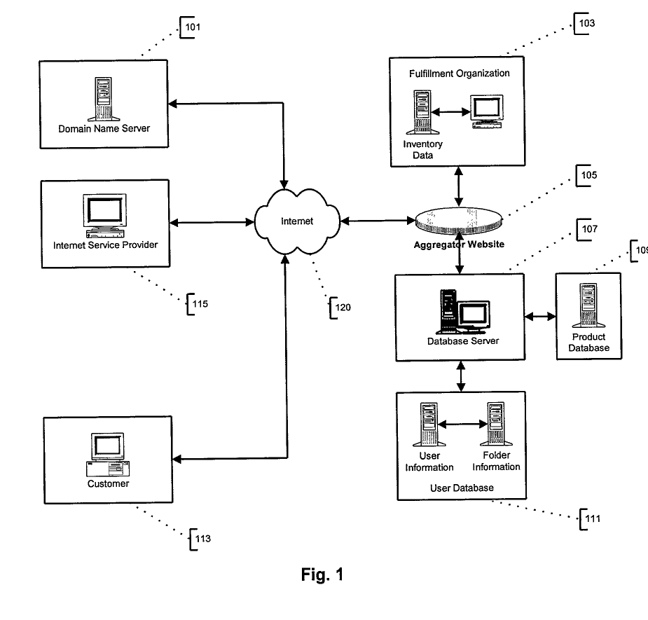

Customers, illustrated by Customer in 113 in FIG. 1, access the Aggregator Website depicted as 107 in FIG. 1 through the Internet 120. The connection to the Website 107 is established by means of an Internet connection provided by an Internet Service Provider as illustrated at 115 in FIG. 1, after having resolved the “Internet Address” of the Aggregator Website by means of a Domain Name Server as illustrated at 101 in FIG. 1.

The term “Internet Address” will be used to refer to the entirety, or a significant part of, a reference to a resource on the Internet. Such a reference may take the form of a numerical Internet Protocol (“IP”) address or an alphanumeric Uniform Resource Locator (“URL”) which may identify on a specific machine, an accessible resource that could range from a file, a database query, a specific command output, among several other things. Thus, the term “Internet Address” includes such things as a specific computer connected to the Internet, written in decimal as 208.36.83.229; a domain name such as “scansupplies.com” which can be resolved into a numerical IP-address using a Domain Name Server 101; the URL of a file accessible via the Internet, such as http://208.36.83.229:8081/login.asp; a URL identifying a query processing script with passed parameters, such as http://scansupplies.com/search%open%blue; or an email address such as support@scansupplies.com, amongst others.

The Product Database, as illustrated by Product Database at 109 in FIG. 1, is stored on a server, as illustrated by Database Server at 107 in FIG. 1. This Database Server 107 may physically reside on or is connected to the Web Server on which the Aggregator Website 105 is hosted. The Product database 109 includes the basic product information such as the Stock Keeping Unit, product name, description, Universal Product Code, Scanbuy Code, price, availability, discount information and other relevant information. The term Stock Keeping Unit (“SKU”) refers to a unique identifier assigned to each product for internal stock-keeping purposes by the supplier, as illustrated by the Fulfillment Organization at 103 in FIG. 1. The Fulfillment Organization 103 has the primary responsibility of managing the Product Database 109; and processing and fulfilling the Orders placed by Customers 113. Each product is uniquely identified by a SKU, which in turn is uniquely associated with a Universal Product Code. The term Universal Product Code (“UPC”) describes the Universal Product Code Version A, whose symbols have 10 digits plus two overhead digits. This UPC code is used by manufacturers and suppliers in the United States and Canada, and is managed by the Uniform Code Council, Inc whose Corporate Office is located at Princeton Pike Corporate Center, 1009 Lenox Drive, Suite 202, Lawrenceville, N.J. 08648. The Scanbuy code (“SBC”) is also a universal product code that is internally generated within the ScanCommerce System to uniquely identify a product. Each SBC also uniquely corresponds to the UPC Code of the particular product. The SBC Code is primarily used to generate the particular product's barcode image to be displayed along with other product information when the User wishes to print product information—i.e. print the information of all products within a chosen folder. The User may scan the barcodes printed on these sheets to generate new Shopping Lists the next time. The codes which will be generated on scanning these barcodes would be SBC Codes that are meaningful only within the ScanCommerce System.

The Database Server 107 also stores information of Customers 113, who are registered on the Aggregator website, in a database, as illustrated by the User Database at 111 in FIG. 1. This User Database 111 stores, amongst other, the basic user information such as the User's Name, Billing and Shipping Addresses, Credit Card information (if the User wishes to save it), and the User's Folder Information. The Folder information essentially comprises the basic folder information such as the Folder Name, Folder Type, etc as well as the information of products that are stored in the Folder such as the SKU, and quantity. In order to eliminate ambiguity and error in pricing, the price and discount information of products included within “work-in-progress” folders, such as the Shopping Cart, are stored outside of these folders i.e. price is stored only in the Product Database 109 and not in the Folder Information in the User Database 111. However, in case of certain folders such as the Purchase Requests, Orders/Purchase Orders folders, the price “as purchased” is stored within these folders in the User Database 111.

### Creation of Standard Folders

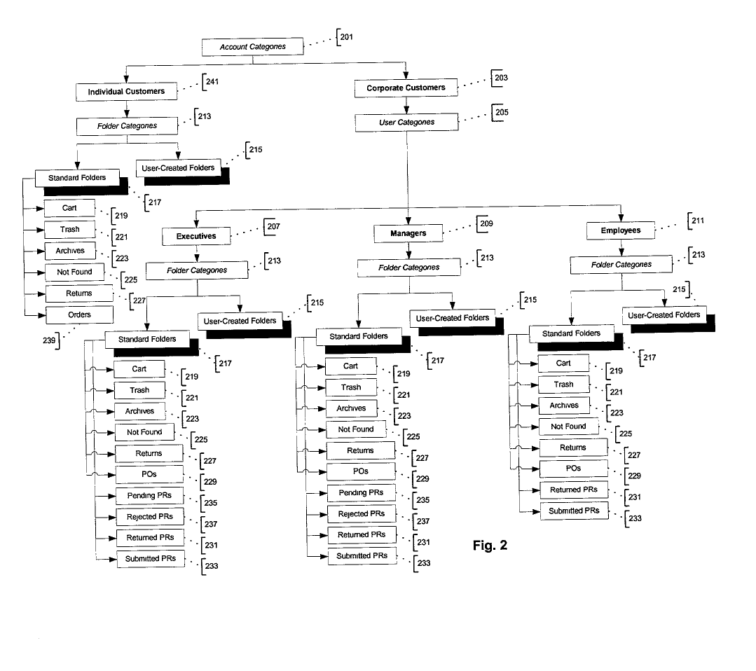

When Customers 113 register on the Aggregator website, they are immediately provided with a range of Standard Folders, illustrated by Standard Folders at 217 in FIG. 2. In other words, these Standard Folders 217 are created automatically when the Customer's (i.e. User's) account is created. The number and type of Standard Folders 217 varies depending on the type of Customers 113, who may belong to either of the two categories illustrated by Account Categories at 201 in FIG. 2. Depending on these Account Categories 201, the User may either be an Individual Customer as illustrated at 241 in FIG. 2 or an employee of businesses as illustrated by Corporate Customers at 203 in FIG. 2. Individual Customers 241 are individuals who shop in an individual or personal capacity, while Corporate Customers 203 comprise businesses or companies in which employees shop in an official or professional capacity. Users in case of Corporate Customers 203 are of three types, as illustrated by User Categories at 205 in FIG. 2. In other words, the business has three kinds of Users or employees as illustrated by Executives 207, and Managers 209, and Employees 211, which are the three User Categories 205. The term “employee” (lower case) shall generically refer to any employee within the Corporate Customer company, while the term “Employee” (title case) shall refer to Users belonging to the User Category of Employee 211. In fact, there is another User Category 205 within employees of Corporate Customers 203 that is not depicted in any of these diagrams i.e. that of an Account Administrator. As the Account Administrator's task is to administer the Company Account and the various Users within the company, s/he does not have any shopping functions and hence is not provided with any folder. This is the reason why the Account Administrator, either as a Role or as a User, has been kept out of the purview of these descriptions.

It may be noted that despite the variation in the kind and number of Standard Folders 217 for different Users, each of these standard folders have similar characteristics:

automatic creation: These folders are automatically created at the time of creation of the User Account (by means of a Business Logic Component implemented as a COM Object).

a pre-determined purpose: For instance, scanned barcodes are downloaded into the Shopping Cart folder, illustrated by Cart at 219 in FIG. 2, either automatically at login or when User clicks on a “Download” button from any web page on the Aggregator Website (except one case when User clicks on a “Download” button when the Returns Folder 217 is open, in which case the barcodes will be downloaded into the Returns folder). Customers can checkout only from the Cart 219 folder. The term “Download” button is used for a hyperlink, available on the User's “Device Manager” panel, which when clicked activates an ActiveX component that downloads the barcodes from the Scanner into the Web Server in the form of a text file. The term “Device Manager” refers to a section, on the default HTML page that the User accesses immediately upon login, that provides two hyperlinks to manage the Scanner—i.e. ‘Download’, and “Clear”. The Download hyperlink or button has already been described above. The “Clear” button or hyperlink is used to erase the Scanner memory i.e. to remove or clear all the barcodes that are stored in the Scanner memory.

inability to rename or delete: None of these folders may be either renamed or deleted. The names of the standard folders are automatically inserted by the Business Rule Object at the time of creation of these folders

When a User gets created, the relevant Business Rule Object method for creation of Standard Folders is invoked by an Application Server Page immediately after creating the basic User tables. The term Application Server Page (“ASP”) shall refer to web pages implemented using the Microsoft Application Server Pages technology.

### Standard Folders for Individual Customers

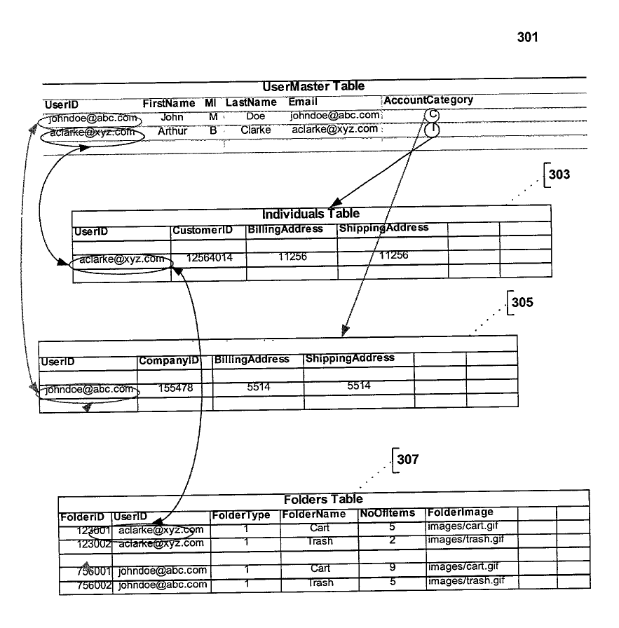

In case of Individual Customers 241, the basic User tables (or the main tables for Individual Customers within the User Database 111) are comprised of the UserMaster table, illustrated by UserMaster Table at 301 in FIG. 3; the Individuals table, illustrated by Individuals Table at 303 in FIG. 3; the Customers table; and the Personal Address Book table. Records for the User are inserted in these tables by appropriate functions or methods invoked by the “Individual Customer Registration” ASPs. The User's record in the UserMaster Table 301 is created first after assigning a UserID which is the Primary Key for this table. The AccountCategory field is automatically replaced by the character “I”; and the IsActive flag is set to True at the time of creation of the UserMaster record for the Individual Customer 241. The PIN field is not written into at the time of creation of the UserMaster record. All other fields in this table are written into using the values accepted in the appropriate “Individual Customer Registration” ASPs. Next, a record for the User is inserted in the Customers Table by automatically generating a CustomerID. The Customer Description field in this Customers Table is not used presently and is reserved for future use. The User's various addresses are then collected by means of an “Individual Customer Registration” ASP and appropriate number of records (one for each address entered by the User) is inserted into the PersonalAddressBook Table. The AddressID is automatically generated. The AddressType field is blank (reserved for future use) while the AddressLabel field carries one of the following values: “BILLING ADDRESS”, or “SHIPPING ADDRESS”, or “MAILING ADDRESS”. In case only one address was created (i.e. if Billing and Shipping Addresses are the same; and/or Mailing address was either left blank or is the same as any of the previous two), the AddressLabel field of the single record will have the value: “BILLING ADDRESS”. Finally, a record is inserted into the Individuals Table 303 after collecting the appropriate field values from the User through an ASP; using the UserID field of the UserMaster Table 301 as the Foreign Key (which becomes the Primary Key of this table); and also using the previously created AddressID field/s of the Personal Address Book Table as Foreign Keys for the Billing, Shipping and Mailing Address (ID) fields.

Once the basic User tables for the Individual Customers 241 are created, five Standard Folders are also created for the User. In other words, five records are inserted in the Folder Master table, illustrated by Folders Table at 307 in FIG. 3, using the UserID in the Individuals Table 303 as the Foreign Key. The FolderID fields in the Folders Table 307 are automatically generated. The FolderType field is inserted into the table programmatically (i.e. through the same Business Object method) using one of the values: 1 to represent folders of Folder Type 1 (Cart, Trash, Archives, Returns); 4 to represent folders of Folder Type 4 (Orders). The FolderName field is inserted automatically using the name of the folder (e.g. Cart). The FolderDescription field is reserved for future use. The Folderlmage field stores the path of the image file, while the NoOfItems field is initially set to 0 (i.e. at the time of creation of these folders). The DateCreated field is written into using the current system date. None of these folders have any “folder content” i.e. child records at this time.

These folders are described in detail in the following paragraphs.

The Cart 219 is the primary folder in which the scanned barcodes are downloaded by default i.e. when the User logins in to the site, the barcodes stored in the Scanner memory are downloaded automatically to this folder. Alternatively, regardless of which web page the User is currently viewing (except when the Returns Folder is open), the barcodes get downloaded into the Cart Folder when the User clicks on a “Download” button. This is the folder that is to be used for Shopping i.e. Users can click on the ‘Checkout’ link available on the Shopping Cart page to initiate the Order Placement process.

As mentioned earlier, there is only one instance in which barcodes can be downloaded into another folder i.e. the Returns folder 227. This folder is used to store the barcodes of products that have been ordered and delivered, but the User wishes to return due to various reasons such as Damaged product, Defective product, or because the User did not like it, or did not want it anymore. Barcodes can be downloaded from the Scanner directly into this folder by first opening this folder, and then clicking on the “Download” hyperlink. In this scenario, barcodes do not get downloaded in the Cart folder as is usually the case. Once the barcodes have been downloaded into the Returns folder 227, the User clicks on the “Checkout” hyperlink to send the information (of products to be returned) to the Fulfillment Company 103.

The Trash Can folder, illustrated by Trash at 221 in FIG. 2, stores the information the products that were earlier contained in folders that were either emptied or deleted.

The Archives folder, illustrated by Archives at 223 in FIG. 2, stores the main information of all the products that the Customer has bought in the past.

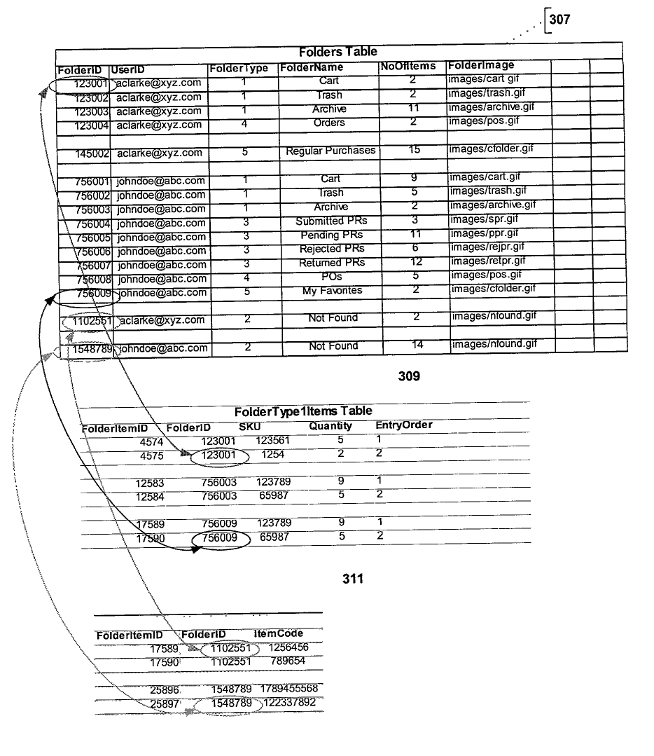

Folder Items, of these four folders described above, have similar structure and hence are stored in the Folder Type 1 Details table, illustrated by FolderType1Items Table at 309 in FIG. 4.

The fifth folder which is created at the time of User Account creation is the Orders Folder, illustrated by Orders at 239 in FIG. 2. This folder is used to store the basic Order Header information, while details of the items are stored in related tables described in subsequent sections.

The Individual Customer has another folder—the Not Found folder, illustrated by “Not Found” at 225 in FIG. 2, which stores the barcodes of products that were scanned but could not found in the Product Repository on the Aggregator Website. In other words, the codes that were downloaded did not match with either the UPC Codes or the SBC Codes of the products within the Product database 109. This folder is not created immediately upon the successful creation of the User Account, but only at the instance when the first indeterminate code is encountered (in the list of barcodes the User had scanned and uploaded).

### Standard Folders for Corporate Customers

In case of Corporate Customers 203, the basic User tables (or the main tables for Corporate Customers within the User Database 111) are comprised of the UserMaster table, illustrated by UserMaster Table at 301 in FIG. 3; the Companies table, Customers table, the Company Locations table, the Customer Companies table, the Employees table, and the Customer Company Employees table, illustrated by CustomerCoEmployees Table at 305 in FIG. 3.

Records for the User are inserted in these tables by appropriate functions or methods invoked by the “Customer Companies Registration” ASPs.

A record in the Companies Table is created first after collecting Company information and assigning a CompanyID which is the Primary Key for this table. The CompanyType field is automatically replaced by the character “C”; and the IsActive flag is set to True at the time of creation of the Companies record. The Company's various locations are then collected by means of an “Add Company Locations” ASP and appropriate number of records is inserted into the CompanyLocations Table. The Primary Key LocationID is automatically generated, while the CompanyID is a Foreign Key from the Companies Table. The AddressType field is blank (reserved for future use). Next, a record is inserted in the Customers Table by automatically generating a CustomerID. The CustomerDescription field in this Customers Table is not used presently and is reserved for future use. Next, a record is created in the CustomerCompanies Table, whose Primary Key is the CompanyID (a Foreign Key from the Companies Table). The Customer Company's Billing, Shipping and Mailing Address are inserted using LocationID (Foreign Keys from the CompanyLocations Table). The User's record in the UserMaster Table 301 is created next after assigning a UserID which is the Primary Key for this table. The AccountCategory field is automatically replaced by the character “C”; and the IsActive flag is set to True at the time of creation of the UserMaster record for each User created in the Corporate Customers Account. The PIN field is not written into at the time of creation of the UserMaster record. All other fields in this table are written into using the values accepted in the “Add Company User” ASP. Next, a record is inserted into the Employees Table for each User, where the Primary Key UserID is a Foreign Key from the UserMaster Table 301. The CompanyID of the Companies Table is used as a Foreign Key. The Description field is left blank (reserved for future use); while the User Category field depends on the class or kind of User being registered: X in case of Executives 207, M in case of Managers 209, and E in case of Employees 211. The Manager ID for a particular User is selected from amongst the User IDs (in the same table) of Users already registered as Managers 209. Finally, a record is inserted into the CustomerCoEmployees Table 305 using the UserID field of the UserMaster Table 301 as the Foreign Key (which becomes the Primary Key of this table); using the CompanyID field of the CustomerCompanies Table as a Foreign Key; and also using the previously created LocationID field/s of the CompanyLocations Table as Foreign Keys for the Billing, Shipping and Mailing Address (ID) fields for the User.

Once the basic User tables for the Corporate Customers 203 are created, Standard Folders are also created for each User. In other words, records are inserted in the Folder Master table, illustrated by Folders Table at 307 in FIG. 4, using the UserID in the CustomerCoEmployees Table 305 as the Foreign Key. The FolderlD fields in the Folders Table 307 are automatically generated. The FolderType field is inserted into the table programmatically (i.e. through the same Business Object method) using one of the values: 1 to represent folders of Folder Type 1 (Cart, Trash, Archives, Retums); 2 to represent folders of Folder Type 2 (Not Found); 3 to represent folders of Folder Type 3 (Purchase Requests), 4 to represent folders of Folder Type 4 (Orders/Purchase Orders); 5 to represent folders of Folder Type 5 (User-Created Folders, which are similar to folders of Folder Type 1 in structure but different with respect to properties e.g. User-Created Folders can be renamed or deleted). The FolderDescription field is reserved for future use. The FolderImage field stores the path of the image file, while the NoOfItems field is initially set to 0 (i.e. at the time of creation of these folders). None of these folders have any “folder content” i.e. child records.

As mentioned earlier, the number and kind of Standard Folders varies from User to User and these are illustrated in FIG. 2. All the ten Standard Folders are created for both Executives 207 as well as Managers 209. It may be noted that nine of these folders are created at the time of User Account creation, while the “Not Found” folder 225 is created at the first occurrence of a downloaded barcode that could not be identified or found within the Product Database 109 of the Aggregator Website 105. Five of these standard folders (Cart, Trash, Archives, Not Found, Returns) are exactly similar to the corresponding folders of the Individual Customers 241.

The Purchase Order folder, illustrated by POs at 229 in FIG. 2, corresponds to the Orders folder 239 of Individual Customers 241. Details of these POs are stored in the POFolders table, and the products which are ordered are saved in the POFItems table.

The other folders that are unique to Users in Corporate Customer companies are the remaining four folders: Pending Purchase Requests illustrated by Pending PRs at 235 in FIG. 2; Rejected Purchase Requests illustrated by Rejected PRs at 237 in FIG. 2; Returned Purchase Requests illustrated by Returned PRs at 231 in FIG. 2; and Submitted Purchase Requests illustrated by Submitted PRs at 233 in FIG. 2.

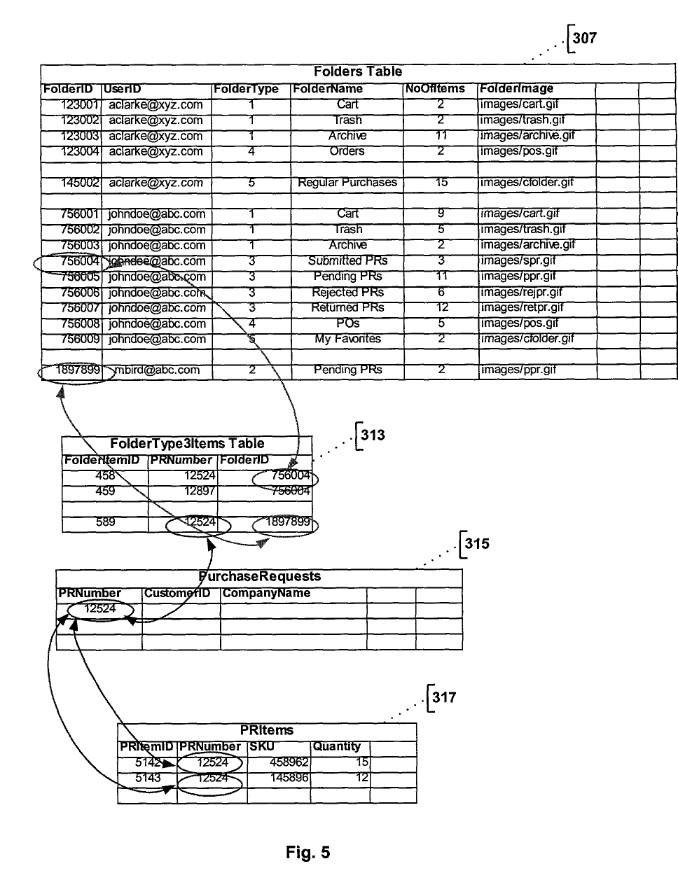

The basic information of these folders are stored in the same Folders Table as illustrated at 307 in FIG. 4. Details of these folders are stored in the FolderType3Items table, as illustrated at 313 in FIG. 5. This table stores the association between the Folders and the Purchase Requests i.e. the FolderID and the PRNumber. The Purchase Request information is stored in the PurchaseRequests table, illustrated at 315 in FIG. 5. Each PR has a number of products, records of which are stored in the PRItems table, illustrated at 317 in FIG. 5.

Pending PRs 235 folder is used to list all the Purchase Requests that are submitted to the User by a subordinate for approval.

Once the PR is approved by the User, it is moved into either the User's Submitted PRs Folder 233 if the User sends it for further approval by his/her superior; or the User's POs folder 229 if the User can place the Order directly without getting it reviewed/approved by a superior.

If the User rejects the PR, it is moved into the User's Rejected PRs folder 237.

If the PRs sent by the User to his/her superior are rejected (i.e. returned), they are saved in the Returned PRs folder 231.

### Creation of User-Created Folders

A Customer User can create any number of shopping lists, or customized Folders, tailored to his requirements. The User clicks on the “Create Folder” hyperlink in the “Folder Manager” after which a dialog box opens in which the User can specify the Name of the Folder. The term “Folder Manager” refers to a section, on the default HTML page that the User accesses immediately upon login, which provides several hyperlinks that are used to manage the User's folders.

If the User clicks the “Cancel” button, the dialog box is closed.

If the User clicks the “OK” button in the dialog box, a record is inserted in the Folders table 307, in which the FolderID is automatically generated and the UserlD of the relevant User Table (Individuals Table 303 in case of Individual Customers or CustomerCoEmployees Table 305 in case of Corporate Customers) as the Foreign Key. A value of 5 is inserted in the FolderType field wherein 5 represents folders of Folder Type 5 (User-Created Folders). These are similar to folders of Folder Type 1 in structure but different with respect to properties e.g. User-Created Folders can be renamed or deleted whereas Standard Folders cannot be either renamed or deleted. The FolderDescription field is reserved for future use. The Folderlmage field stores the path of the image file. The default path of the image for User-created folders is automatically inserted in this field. The NoOfItems field is initially set to 0 (i.e. at the time of creation of these folders). The DateCreated field is written into using the current system date. None of these folders have any “folder content” i.e. child records at this time. Later, when such detail records are created they are also stored in the FolderType1Items Table.

The page is refreshed and an image of the newly created folder is displayed in the Folders Frame (with its name, and no of items within the folder i.e. 0 displayed just below the image). “Folders Frame” refers to a Frame on the User's HTML page that provides a listing of all folders available or accessible to the User.

### Deletion of Folders

When the User clicks on the “Delete Folder” hyperlink in the Folder Manager, the User's current location is first checked i.e. it is first checked whether the User has any folder open. If no folder is open, an error message “Please select the folder to delete” is displayed. If a folder is currently selected (or open), it is checked whether it is a Standard Folder or a User-Created folder.

Standard Folders cannot be deleted, so if the User tries to delete a standard folder an appropriate error “This folder cannot be deleted” is displayed.

If the User had selected one of his/her User-Created folders, a confirmation dialog box is first displayed with the message “Are you sure you wish to delete this folder and move its contents into Trash?”.

If the User clicks the “Cancel” button, the dialog box is closed.

If the User clicks the “OK” button in this dialog box, the folder entry in the Folders table 307 is deleted, while the folder item details stored in the FolderType1ltems are moved to the Trash—i.e. the FolderID of the User's Trash folder is determined and replaced in the FolderID field of each of the FolderType1Items records. It must be checked whether there are duplicate entries of SKUs in the Trash folder; and if so, only one record needs to be saved. This record will have a Quantity which is the summation of all such records i.e. sum of quantity in record/s deleted and the quantity in the original Trash folder record.

### Renaming Folders

When the User clicks on the “Rename Folder” hyperlink in the Folder Manager, the User's current location is first checked i.e. it is first checked whether the User has any folder open. If no folder is open, an error message “Please select the folder to rename” is displayed. If a folder is currently selected (or open), it is checked whether it is a Standard Folder or a User-Created folder.

Standard Folders cannot be rename, so if the User tries to rename a standard folder an appropriate error “This folder cannot be renamed” is displayed.

If the User had selected one of his/her User-Created folders, a confirmation dialog box is first displayed with the message “Are you sure you wish to rename this folder?”.

If the User clicks the “Cancel” button, the dialog box is closed.

If the User clicks the “OK” button, another dialog box is displayed—which shows the Current Name, and a textbox to collect the new name. The FolderName in the Folders table 307 is then updated with this value collected, when the User clicks on the “OK” button. If the User clicks the “Cancel” button, the dialog box is closed without renaming the folder.

### Emptying Folders

When the User clicks on the “Empty Folder” hyperlink in the Folder Manager, the User's current location is first checked i.e. it is first checked whether the User has any folder open. If no folder is open, an error message “Please select the folder to empty” is displayed.

A confirmation dialog box is then displayed with the message “Are you sure you wish to empty this folder i.e. move its contents into Trash?”.

If the User clicks the “Cancel” button, the dialog box is closed.

If the User clicks the “OK” button in this dialog box, the folder item details stored in the FolderType1ltems Table are moved to the Trash—i.e. the FolderID of the User's Trash folder is determined and replaced in the FolderID field of each of the FolderType1Items records. It must be checked whether there are duplicate entries of SKUs in the Trash folder; and if so, only one record needs to be saved. This record will have a Quantity which is the summation of all such records i.e. sum of quantity in record/s deleted and the quantity in the original Trash folder record.

### Printing Folder Contents

When the User clicks on the “Print” hyperlink in the Folder Manager, the User's current location is first checked i.e. it is first checked whether the User has any folder open. If no folder is open, an error message “Please select a folder” is displayed.

If a folder is currently selected (or open), a new Browser window is opened in which the product information is displayed along with the barcode (image) which is generated using a third-party component. The Windows Print Dialog box is displayed next, and if the User clicks “OK” the page as displayed in the new window is printed.

### Inserting Folder Detail Records

Creation of various folders have been described in earlier sections. When these folders are created (at the time of User Account creation), none of them have any Detail records i.e. records in the child tables. This section describes the manner in which the detail records are created.

When the User clicks on the Download button, the barcodes are translated into the UPC Code or SBC Code, as the case may be, by an ScanCommerce Decoding Algorithm component. These codes are mapped to SKUs and information saved in the Shopping Cart.

These detail records are saved in the FolderType1ltems Table, with the FolderID of the User's Cart Folder record (in the Folders Table) as the Foreign Key in the FolderType1Items Table.

The process of inserting detail records in the Trash Folder have been explained above (deletion of folders and emptying folders).

Detail records of Not Found folders are inserted when downloaded barcodes cannot be resolved and/or mapped to any SKU in the Products Database 109. Each of these Codes are stored in a record of the FolderType2Items Table, wherein the FolderID of the User's Not Found folder is the Foreign Key, and the DateCreated is replaced by system date of the day on which the record was created.

Detail records of Archives folders are inserted when the User successfully places an Order—details of all the items on the Order are saved into the FolderType1Items Table—one record for each item. The FolderID of the User's Archives folder is the Foreign Key, and the DateCreated is replaced by system date of the day on which the order was placed.

Detail records of the Purchase Request folders are created when Purchase Requests are created by Users (i.e. when the User creates and submits a PR to his/her superior for approval). For each purchase request, the following folder detail tables are created: PurchaseRequests, PRItems, PRShippingDetails or PRPickupDetails, PRPOPayment or PRCCPayment. PRRouting records are created each time the PR is sent from one User to another.

Similarly, detail records of the Orders (in case of Individual Customers) and Purchase Orders (in case of Corporate Customers) are created when any User successfully places an Order. For each Order/Purchase Order, the following folder detail tables are created: POFolders, POFItems, POFShippingDetails or POFPickupDetails, POFPOPayment or POFCCPayment.

It must be noted that when a PR gets converted into a PO, the PurchaseRequest records are first copied to corresponding PurchaseOrder tables, and PurchaseRequest records get deleted. Then, PurchaseOrder tables are copied into POFolders tables, using the PurchaseOrder ID field of the PurchaseOrders Table (a Foreign Key) as the primary Key of the POFolders Table. This redundancy element helps to isolate the two sets of tables which are used by different User categories—the POFolders tables are used/managed by the Customer Company Employees while the PurchaseOrder tables are used/managed by the employees of the Fulfillment Organization 103. It must be noted that PurchaseRequest tables as well as POFolders tables are folders tables included in the Users Database 111; while Purchase Orders are not folder tables, but part of the Orders Database.

### Updating Folders

One of the ways of updating folders is to change the quantity from within the folder listing ASP. The other way is to use the Drag-and-Buy component of the ScanCommerce System described in the Drag-and-Buy paragraph on page 15. The Drag action requires identification of the “item selected from the Source folder” i.e. the SKU; and the Drop action requires identification of the “Destination Folder”.

Each Drag-and-Buy action will:

Keep the quantity same in the Source folder (i.e. the folder whose listing is shown in the Middle Frame)

Increase the quantity of the product in the Destination folder by ONE (if the product already exists in the Destination folder)

If the product does not already exist in the Destination folder, the product will get inserted in the Destination folder with a quantity of ONE.

The following folders cannot be updated: Purchase Requests, POFolders, Not Found, and Archives. In other words, no item can be dragged from a folder and dropped into these folders. Quantities cannot be changed. However, items may be dragged out of these “non-updateable” folders into other folders.

The Drag-and-Buy component, described in the following paragraphs, is used in conjunction will all the folders to move product information from one folder to another using Drag-and-Buy; and then ordering the contents (products) within the folder.

### Drag-and-Buy

“Drag-and-Buy” refers to the process of dragging and dropping product information between different Shopping Folders and from these into the Shopping Cart; after which the user will check out to place the Order.

The User first opens a Source Folder by clicking on the icon of the folder, say Archive. When the folder is opened, the folder contents (the information on products contained within the folder) are displayed on the Computer/Appliance Screen: Product Image, Product Name & Description, Price, Unit, Quantity and the Total.

The User can move or copy any of the products from this folder into any of the other folders by using the Drag-and-Buy component of the ScanCommerce System. The “Drag-and-Buy” component refers to a collection of DHTML functions, which allows the User to click on a icon of an item in the folder listing, hold the mouse button down, and drag that item across the screen to another location—i.e. on the icon of the Destination Folder (in the Folder Frame), whereupon the customer releases the mouse button. This act designates that the dragged product is placed into the folder that it was dropped into.

The User first positions the mouse over the product image, left-clicks/depresses the mouse button over on the icon of the product from the open folder. This action is used identify and capture, in a variable, the SKU of the product which has been selected.

The user than keeps the mouse button pressed, and moves the cursor to the desired location i.e. over the icon of the “Destination Folder”—the folder in which the product is to be “dropped”. The User then releases the mouse button when the cursor is positioned over the Destination Folder icon. When the mouse button is released, Folder ID of the Destination Folder is identified and captured in another variable.

The SKU of the product, that is stored in the first variable, is first searched in the Destination Folder. If the SKU is found, the Quantity of the product within this folder is increased by lif the SKU is not found, an entry is inserted into the folder using this SKU and a Quantity of 1.

The page is refreshed once the above actions are completed for each Drag-and-Buy operation.

It may be noted that standard DHTML functions are used to implement Drag-and-Buy—i.e. to identify the origin and destination, to show the User that Drag-and-Buy actions are being executed. It may also be noted that the following folders cannot be updated: Purchase Requests, Orders/PO Folders, and Archives. In other words, no item can be dragged from a folder and dropped into these folders. Quantities cannot be changed. However, products can be dragged out from these folders to be dropped into other folders.

### Checking Out and Ordering

Once the products have been organized into various folders, the Cart folder is opened when the User wishes to place an Order. When the User clicks on the “Checkout” hyperlink when the Cart folder is displayed, the first page of the Order Form is displayed wherein the product information (as on Order) are displayed. The User completes the Order Form in the manner as described below.

The Delivery Option is collected from the User. If the User's choice is “Pickup”, the User has to select the pickup time slot and pickup location from the options given. The User has to also specify the name of the person who will be accepting delivery and a PIN to help identify the person who is authorized to accept delivery. If the User has selected the “Delivery” option i.e. when User wishes the Goods to be shipped, the shipping address is collected from the User through the same form. The User's default Shipping Address is automatically replaced in the relevant textboxes on the HTML page (if the User has saved this information) and this may be changed or updated by the User. The User may enter the codes of Coupons that he/she may wish to redeem.

On the next HTML page, the Order information is displayed again along with the amount to be paid after calculation of Shipping & Handling charges, Tax, and any adjustment of coupons. The Payment Option is then collected from the User. If the User's choice is “Credit Card”, the User has to select the appropriate Credit card from the Wallet if it is saved on the Aggregator Site. The Credit Card information, as saved, is displayed in relevant textboxes on the HTML page and the User is allowed to change or update this information. If the User selects “PO”, the Credit Card information is note collected; rather, the Payment Terms are selected from a list that is displayed. On the same page, the User is also displayed the default Billing Address, which is automatically replaced in the relevant textboxes on the same HTML page (if the User has saved this information) and this may be also be changed or updated by the User. The User then “submits” the Order.

If the payment method is “Credit Card”, the Credit Card information is verified online by integration of the system with a Payment Gateway, such as CyberCash. If the Credit Card is verified, the Payment is authorized. If the Credit Card is not verified, an error message is displayed and the User has to re-enter valid Credit Card information.

In case of Individual Customers, the Order gets placed in the manner described above. However, in case of employees of Corporate Customers, submission of the “Order” as described above leads to creation of either a Purchase Order (if the User is authorized) or a Purchase Request which is routed to his superior (if the User is not authorized to create a PO). In case of Purchase Requests, the PR is routed until the final authority after which it gets converted into a PO if it's approved. The PR/PO information gets saved to the relevant PR/PO folder.

### ScanFind

“ScanFind” refers to methods and system for searching and recommending a substitute when a product is not found in the Product Repository on a website implementing the ScanCommerce Web Application.

“ScanFind” is a component of the ScanCommerce System that will seek Substitutes for products that are either “Not Sold” or “Sold Out i.e. Not in Stock”. This Component, essentially, tries to identify the product details from the UPC Code of the product that User wishes to buy; and if this product is not found in the Products Repository, compares the details of this product with the details of products available in the Product Repository; and if they match, record the product in the Repository as a Substitute of the original product searched for. For each substitute found, an entry is added to the Substitutes Table, as well as the “ScanFind Results” folder. In other words, the substitutes (substitute products) identified by the ScanFind processes are stored in the “ScanFind Results” folder in the same format as in the other folders e.g. Image, Product Name (and Description), Unit, Price, Total, and so on.

When scanned barcodes are downloaded—either automatically when the User logs in, or when the User clicks in the Download button, each downloaded codes has to be first read and searched in the Products Database. When the scanned barcode is a Scanbuy Code (SBC), there is no problem because this code would be identified (i.e. since it already exists in the Product Database). When the scanned barcode is a UPC Code, this code would be identified if it exists in the Product Database, and it will be saved in the Shopping Cart. If the UPC Code does not exist, the ScanFind component will search for the UPC code in the other databases and try to determine and recommend a substitute, as described by the process below.

The UPC code is first searched in a Substitutes table. If it is found, the SKU of the Substitute is read from the Substitutes table. This SKU is then searched in the ProductMaster table, and the product details are fetched into a variable. The Error & Substitution Message, stating that the scanned code was not found but a Substitute Product was found. The product details may be displayed and the User may be queried if s/he wishes to accept the substitute. If the User accepts the substitute, it is saved in the Cart and the next code in the list is read. In an alternative implementation, information of all substitutes may be saved in an array and all such messages may be displayed at the end rather than one by one.

If the UPC code were not found in the Substitutes table, it is first searched in an internal UPC Database; and if it is not found in the internal UPC Database, it is searched in external UPC Registries. If it is still not found in any external UPC Registry, the code is inserted in the “Not Found” folder and a “UPC Not Found!” error message displayed. The ScanFind operation terminates at this point. The Not Found folder stores the barcodes of products that were scanned but could not found in the Product Repository on the Aggregator Website. In other words, the codes that were downloaded did not match with either the UPC Codes or the SBC Codes of the products within the Product database.

As mentioned earlier, the ScanFind component will not be able to recommend a product in either of the two conditions:

if the UPC code has not been identified because it is not found in all of the following repositories:

Products Database, UPC Database, and UPC Registries

if the UPC codes has been identified, but its substitute could not be identified in the Products Database

If the UPC code were found either in the internal UPC Database or the external UPC Registry/ies, the product name, product descriptions (and/or other product attributes) are fetched. From the beginning to the end of the ProductMaster table, these product attributes from the UPC Database or UPC Registry are compared/matched with the corresponding attributes in the ProductMaster table, through a set of business rules. If there is a match (even to a certain degree), the SKU is fetched from the ProductMaster table. A record in then inserted into the Substitutes table using the UPC code in the “UPC” primary key field, the SKU determined from the ProductMaster table in the “SubstituteSKU” field, and the “Degree of Closeness”, computed through a set of business rules, into the “Closeness” field. Next, the process loops to display the Error & Substitution Message. If the EOF is encountered in the ProductMaster table, no match was found; hence an error message is displayed.

ScanFind can also be used for another purpose. Some products may go out of stock when a User attempts to place an Order using a Shopping Cart that has been saved for a considerable period of time. During such cases, it is important to prompt the User that s/he may wish to buy a substitute as it may take time to fuilfill the order for the original product. The ScanFind component that checks whether the product has gone out of stock; and if so, recommends the substitute.

This process is very similar to the one just described previously, except for one important fact—that the UPC code (of the product for which a substitute is to be searched) is already known. Hence, in this case, there is no need to look up either the internal UPC Database or the external UPC Registry.

The Order Processing logic seeks for the Shopping Cart entry in the Product Database through the SKU; hence, there is a need to fetch the UPC in the ProductMaster table (using the SKU given in the Cart record). The UPC code is then searched in the Substitute table.

If the UPC code is found in the Substitutes table, the substitute is recommended as described in the previous section.

If the UPC code is not found in the Substitutes table, the product name, product descriptions (and/or other product attributes) are fetched from the ProductMaster table for this particular UPC code. The whole Product Master table (except for the original record) is searched using these attributes. The subsequent processes are as described in the previous section, except when there are no matches found—in which case, the error message that is displayed would read “Product currently out of stock. Substitute not found.”

ScanFind operations also come into play when ScanSearch, the Search component of the ScanCommerce solution, does not find the product/s for which the keywords were entered. The keywords could be a product code (SKU, UPC, or SBC) or some text representing name or description of products; or categories or sub-categories.

In case of SKUs and SBCs, matching records would be found if valid SKUs or SBCs have been entered; and there is no question of ScanFind coming into operation. In case of UPCs, the processes as described in previous paragraphs—since the ScanFind will be activated only if the UPC code were not found in the Products Database.

In case of keywords that are textual, the ScanSearch component would be able to conduct a full textual search of the Product Repository and determine the closest matches. ScanFind is not activated.

It may be noted that systems and methods described above are preferred embodiments or illustrative applications of the principles of the present invention. Numerous modifications and adaptations may be made by those skilled in the art without departing from the true spirit and scope of the invention.

1. The system and method comprises the following steps:
uploading barcodes in using a personal scanner into a centralized repository,
resolving this barcode into appropriate product identification (such as the SKU),
storing this information in the repository in the form of customized shopping lists or folders,
using these lists to conduct online shopping,
creating or printing personalized Catalogs that include the product information of items within these shopping lists along an associated barcode.

2. The system and methods that permits a User to drag and drop information from one folder to another using the drag-and-buy techniques as described in the document, particularly dragging a product from other folders into the shopping cart folder with the intention of using the contents of this folder to conduct online shopping.

3. The system and methods to search and recommend product substitutes when a desired product is not available in the Products Repository—substitutes are searched in an internal Substitutes database, an internal repository of product and manufacturer information based on UPCs, and external registries or repositories of product and manufacturer information based on UPCs.
